(19) United States
(12) Patent Application Publication
(10) Pub. No.: US 2006/0139587 A1
(43) Pub. Date: Jun. 29, 2006

(54) Software mechanism for generating flexible equipment state model views, software mechanism for measuring equipment reliability

(75) Inventors: Harm Roelof Rossing, Nijmegen (NL); Marco Gertruda Lambertus Franssen, Heerlen (NL); Camiel Ben Rouweler, Eindhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/019,543

(22) Filed: Dec. 23, 2004

(51) Int. Cl. G03B 27/42

(52) U.S. Cl. 355/53

(57) ABSTRACT

A state model engine according to one embodiment is configured to dynamically determine Reliability, Availability, and Maintainability data in a lithographic processing system. The engine evaluates whether state changes occur in defined state models, based on transition events published by other state models.

### BACKGROUND

1. Field of the Invention

This invention relates to equipment monitoring and lithographic processing.

2. Background Information

A lithographic apparatus is a machine that applies a desired pattern onto a target portion of a substrate. Lithographic apparatus can be used, for example, in the manufacture of integrated circuits (ICs). In that circumstance, a patterning structure, such as a mask, may be used to generate a circuit pattern corresponding to an individual layer of the IC, and this pattern can be imaged onto a target portion (e.g. comprising part or all of one or several dies) on a substrate (e.g. a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion at once, and so-called scanners, in which each target portion is irradiated by scanning the pattern through the projection beam in a given direction (the “scanning”-direction) while synchronously scanning the substrate parallel or anti-parallel to this direction.

A factory in which semiconductor devices are manufactured (commonly referred to as a “fab” or “foundry”) may include lithographic processing machines (or “equipment”) such as lithographic apparatus. Each lithographic apparatus is commonly grouped with a “track” (e.g. comprising other lithographic processing machines or “equipment” such as wafer handling devices and pre- and post-processing devices) to form a lithographic processing system commonly called a lithographic processing cell or “lithocell.” Both the lithographic apparatus and the track may have supervisory control systems which are themselves under the control of a further supervisory control system.

Wafers, which may be blank or have already been processed to include one or more process or device layers, are delivered to the lithocell in lots (also referred to as batches) for processing. A lot is, in general, a group of wafers which are to be processed by the lithocell in the same way and is accompanied by a “recipe” which specifies the processes to be carried out. The lot size may be arbitrary or determined by the size of carrier used to transport substrates around the fab. The recipe may include details of the resist coating to be applied, temperature and duration of pre- and post-exposure bakes, details of the pattern to be exposed and the exposure settings for that, development duration, etc.

A fab may include a large number of tools, any of which may be idle or otherwise in a nonproductive state at some time. It may be desirable to minimize equipment idle time, e.g. to maximize efficiency, yield, throughput, and profitability. It may also be desirable to monitor the equipment to insure repeatability, reduce waste, and/or anticipate deviations from specification. Keeping track of the various status of the equipment in a working fab is a complex task.

To control or obtain insight in the overall functioning of the equipment, the organization Semiconductor Equipment and Materials International (SEMI) has prescribed state models (or “views”) in several standards (e.g. SEMI E30, E40, etc.) for required external behavior. State models are also defined to measure the equipment's performance (e.g. SEMI E58). Implementation of these state models is typically realized by inserting triggers in the software at fixed positions for each required state model. Modification of these models may be expensive and time-consuming. As a result, provision of user-specific views on the equipment is not feasible.

### SUMMARY

In one embodiment, a method of controlling a lithographic processing machine includes, based on occurrence of a trigger event, recording a transition of a first state model of the machine and, based on a transition event corresponding to the transition, updating a second state model of the machine. In another embodiment, the second state model is derived from the first state model.

### BRIEF DESCRIPTION OF THE DRAWINGS

FIG. 1 shows a lithographic apparatus that may be used in a system according to an embodiment of the invention.

FIG. 2 is a table showing the six basic equipment states defined in SEMI E10.

FIG. 3 is a diagram showing an example of a basic state divided into levels of substates.

FIG. 4 is a diagram of a division of total time into six basic blocks based on the SEMI E10 basic states.

FIG. 5 is a table showing the default transition rules of SEMI E58.

FIG. 6 is a block diagram of a system 50 according to an embodiment of the invention.

FIG. 7 is a diagram of a state transition.

FIG. 8 is a diagram of entry triggers.

FIG. 9 is a flowchart of a counter event.

FIG. 10 is a diagram of a state model showing two levels of interaction between states.

FIG. 11 is a diagram showing two state models according to the model of FIG. 10.

FIG. 12 shows a flowchart of a method M100 according to an embodiment of the invention.

FIG. 13 shows a flowchart of an implementation of task T120 with task T130.

FIG. 14 shows a flowchart of a method M200 according to an embodiment of the invention.

FIG. 15 shows a flowchart of a method M300 according to an embodiment of the invention.

### DETAILED DESCRIPTION

Embodiments of the invention may be applied to implement standards such as SEMI E10 and E58. From such data as the time spent in the various states and the frequency of transitions between states, important performance indicators such as mean time between interrupts (MTBI), mean time to repair (MTTR), availability, and reliability can be determined.

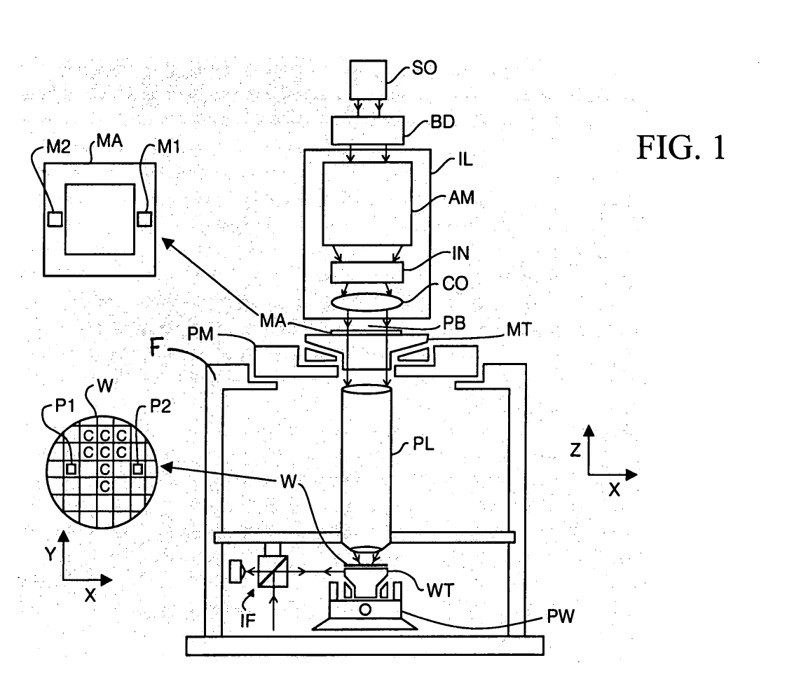

FIG. 1 schematically depicts a lithographic apparatus according to a particular embodiment of the invention. The apparatus comprises an illumination system (illuminator) IL for providing a projection beam PB of radiation (e.g. UV radiation or DUV radiation); a first support structure (e.g. a mask table) MT for supporting patterning structure (e.g. a mask) MA and connected to first positioner PM for accurately positioning the patterning structure with respect to item PL; a substrate table (e.g. a wafer table) WT for holding a substrate (e.g. a resist-coated wafer) W and connected to second positioner PW for accurately positioning the substrate with respect to item PL; and a projection system (e.g. a refractive projection lens) PL mounted on a frame F and configured to image a pattern imparted to the projection beam PB by patterning structure MA onto a target portion C (e.g. comprising one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising for example suitable directing mirrors and/or a beam expander. In other cases the source may be integral part of the apparatus, for example when the source is a mercury lamp. The source SO and the illuminator IL, together with the beam delivery system BD if required, may be referred to as a radiation system.

The illuminator IL may comprise an adjuster AM for adjusting the angular intensity distribution of the beam. Generally, at least the outer and/or inner radial extent (commonly referred to as -outer and -inner, respectively) of the intensity distribution in a pupil plane of the illuminator can be adjusted. In addition, the illuminator IL generally comprises various other components, such as an integrator IN and a condenser CO. The illuminator provides a conditioned beam of radiation, referred to as the projection beam PB, having a desired uniformity and intensity distribution in its cross-section.

The projection beam PB is incident on the mask MA, which is held on the mask table MT. Having traversed the mask MA, the projection beam PB passes through the lens PL, which focuses the beam onto a target portion C of the substrate W. With the aid of the second positioner PW and position sensor IF (e.g. an interferometric device), the substrate table WT can be moved accurately, e.g. so as to position different target portions C in the path of the beam PB. Similarly, the first positioner PM and another position sensor (which is not explicitly depicted in FIG. 1) can be used to accurately position the mask MA with respect to the path of the beam PB, e.g. after mechanical retrieval from a mask library, or during a scan. In general, movement of the object tables MT and WT will be realized with the aid of a long-stroke module (coarse positioning) and a short-stroke module (fine positioning), which form part of the positioner PM and PW. However, in the case of a stepper (as opposed to a scanner) the mask table MT may be connected to a short stroke actuator only, or may be fixed. Mask MA and substrate W may be aligned using mask alignment marks M1, M2 and substrate alignment marks P1, P2.

The depicted apparatus can be used in the following preferred modes:

1. In step mode, the mask table MT and the substrate table WT are kept essentially stationary, while an entire pattern imparted to the projection beam is projected onto a target portion C in one go (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the projection beam is projected onto a target portion C (i.e. a single dynamic exposure). The velocity and direction of the substrate table WT relative to the mask table MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning structure, and the substrate table WT is moved or scanned while a pattern imparted to the projection beam is projected onto a target portion C. In this mode, generally a pulsed radiation source is employed and the programmable patterning structure is updated as required after each movement of the substrate table WT or in between successive radiation pulses during a scan. This mode of operation can be readily applied to maskless lithography that utilizes programmable patterning structure, such as a programmable mirror array of a type as referred to above.

Combinations and/or variations on the above described modes of use or entirely different modes of use may also be employed.

The following terms are used herein. In addition to any other ordinary meaning that these terms may have which is not inconsistent with the context in which they appear herein, these terms will be understood to convey the following meanings:

Condition: A reference to specific states of other state models. A condition is true when the current state of the other state model is the state referenced in the condition.

Counter: An object that counts the occurrence of a specific event (or set of events) during a specific time period (e.g. for the purpose of reporting equipment history).

Derived State Model: A state model that defines transitions based on transition events received from exactly one other state model. In essence, a derived state model filters or translates transition events.

Event: The communication of the occurrence of something of significance to the equipment. The occurrence may be a physical event, and the actual “event” meant here is the communication of that physical event by the software component that detects it. Also, an indication of a transition as published by an internal state model or other state model.

Internal State Model: A state model maintained by a software component and limited to describing the functionality and/or behavior of that component.

State: A condition or situation during the lifetime of an object, during which the object satisfies some condition, performs some activity, or waits for some event to occur. A state may contain substates, which are states themselves, and may be included in a superstate. If a state model is in a state, then it is also in all parent states of that state.

State Model: A set of states and a set of rules (triggers) that define when transitions between the states may occur.

Status Variable: A variable that contains information about the equipment's state. The value of the variable is continuously (or periodically) updated by the equipment and can be read by the monitor.

Substate: A state within another state.

Superstate: A state that includes another state; especially, one of the six basic equipment states.

Transition Event: The communication of the occurrence of a state transition in a state model. It may be desirable for the transition event to be unique for the transition it indicates (i.e. that no two different transitions can publish the same transition event).

Trigger: A trigger defines when a transition to a target state may take place. If the associated event occurs, the state model is in the source state (if applicable), and the transition conditions are true (if applicable), then the current state of the state model is changed to the target state, and the transition event (if applicable) is published.

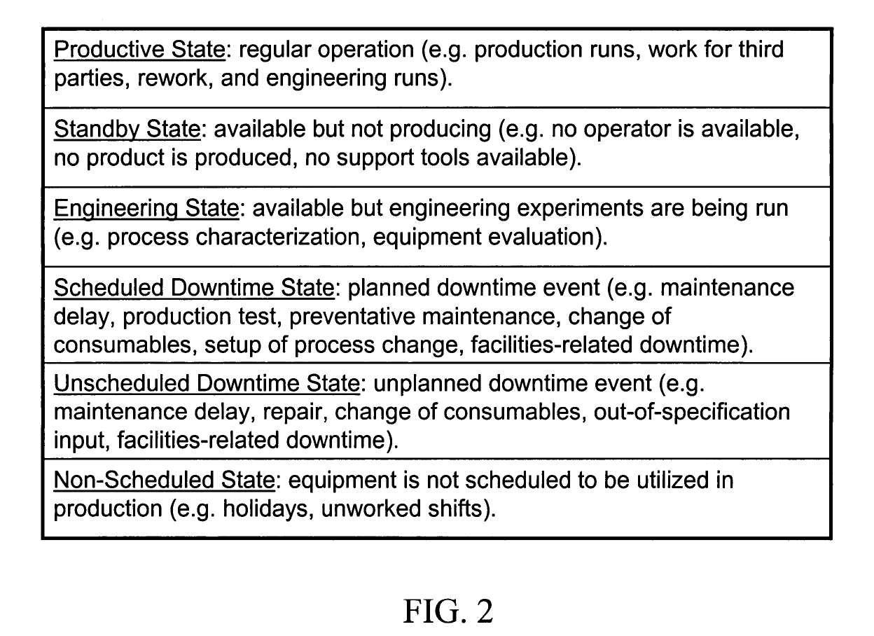

SEMI Standard E10 is the Specification for Definition and Measurement of Equipment Reliability, Availability, and Maintainability (RAM). SEMI E10 defines six basic equipment states into which all equipment conditions and all equipment time must fall: Productive State, Standby State, Engineering State, Scheduled Downtime State, Unscheduled Downtime State, and Non-Scheduled State. The table in FIG. 2 provides a further explanation and examples for each of these six states.

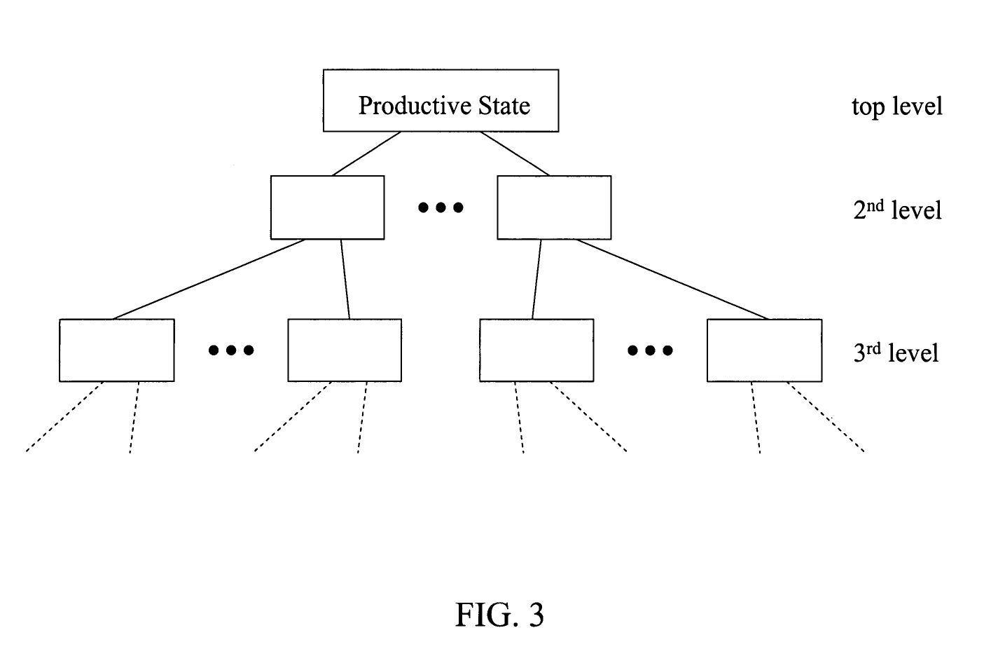

Any of the six basic RAM states may be further defined into substates, which in turn may be further divided into substates. FIG. 3 shows an example in which a Productive state is divided into several levels of substates. Although the default model is only two levels deep, a state model engine according to an embodiment of the invention may be capable of handling views that describe states that are more than two levels deep, i.e. substates in substates in substates and so on (multilevel states).

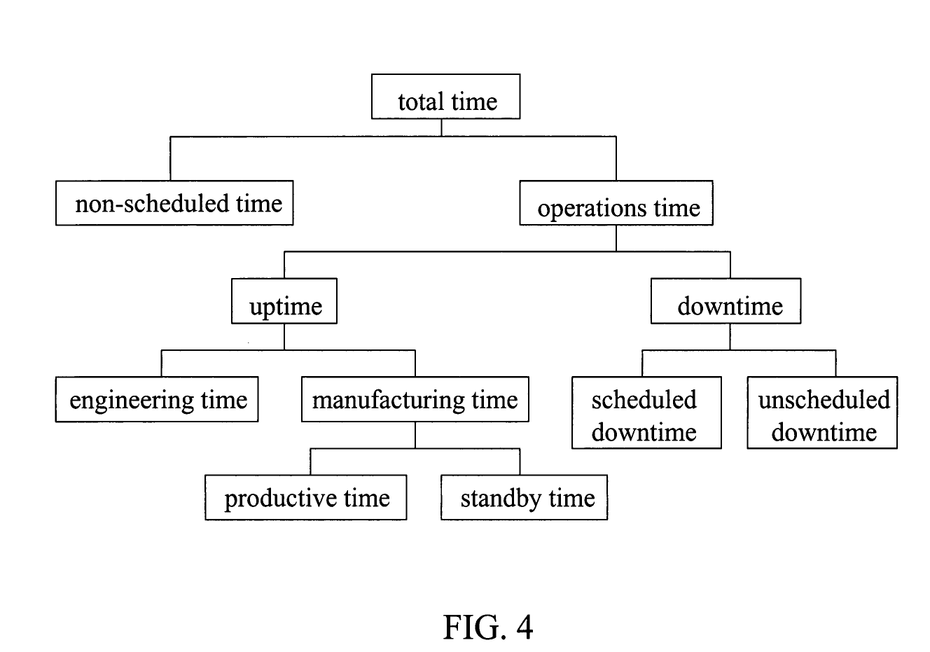

Based on the six basic states, SEMI E10 also defines blocks of time into which total time for equipment is divided (see FIG. 4). Total time for each tool is first divided into Operations Time and Non-Scheduled Time. Operations Time is further divided into five categories: Engineering Time, Productive Time, Standby Time, Scheduled Downtime, and Unscheduled Downtime.

SEMI E10 also defines several RAM metrics relating to equipment performance, including mean time between interrupts (MTBI), mean time between failures (MTBF), mean time between assists (MTBA), mean cycles between interrupts (MCBI), mean cycles between failures (MCBF), and mean cycles between assists (MCBA).

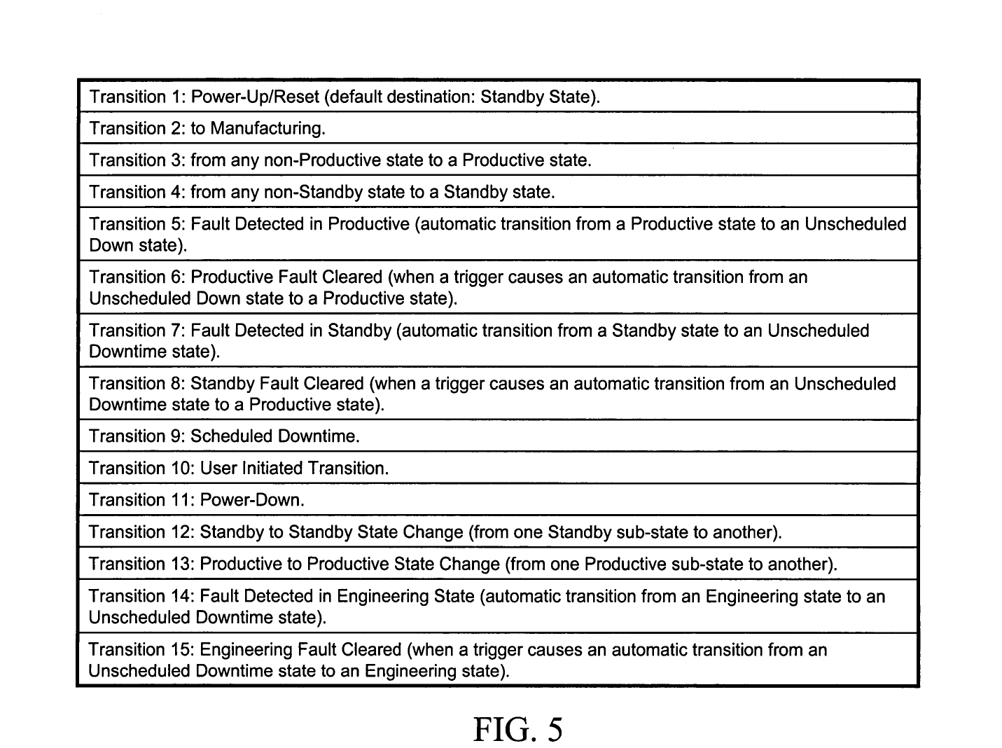

Although SEMI E10 defines equipment states as described above, it was not written specifically for application by automated equipment. SEMI Standard E58, the Automated Reliability, Availability, and Maintainability (ARAMS) Standard, interprets SEMI E10 for automated equipment and provides a consistent interpretation of the basic states through formal state model methodology. SEMI E58 specifies triggers for state transitions described in SEMI E10. SEMI E58 also defines fifteen default transition rules (listed in FIG. 5) and a set of standard codes for representing substates of the six basic equipment states defined in SEMI E10.

SEMI E58 provides guidelines for measuring the performance of semiconductor equipment. These guidelines can be divided into two parts: the first part includes definitions of how equipment time is categorized, and the second part includes definitions of how to measure the equipment performance. SEMI E58 requires these measurements to be done using the basic state model it provides.

SEMI E58 requires the equipment to determine its own state, but does not specify how the equipment shall do so. A mechanism according to an embodiment of the invention may be used to determine the equipment state automatically and in real-time. Such a mechanism may also be used to provide new functionality that users can apply to create user-specific views of the system.

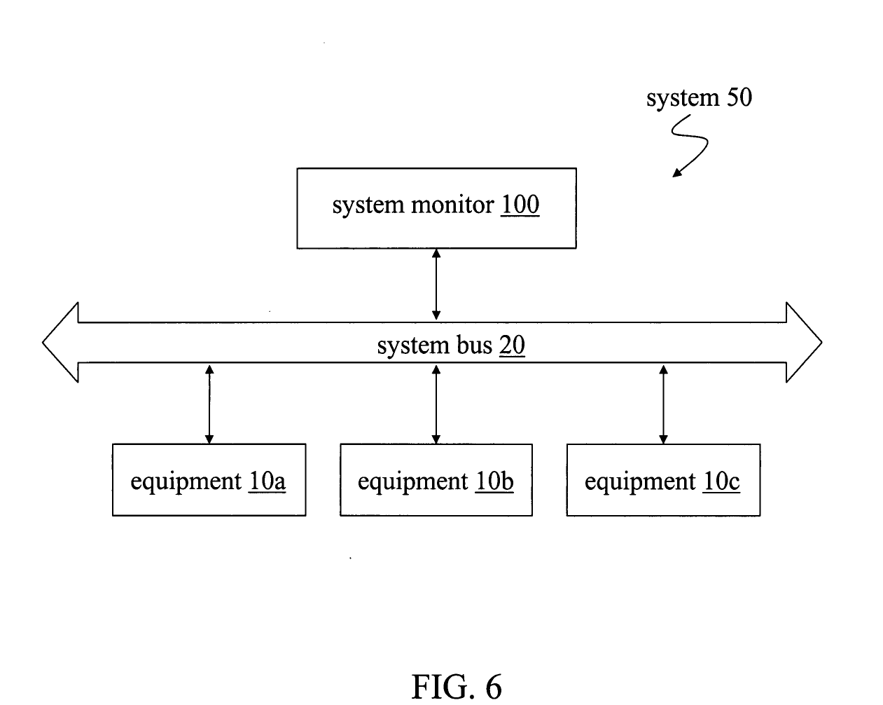

FIG. 6 shows a block diagram of a system 50 according to an embodiment of the invention. System 50 includes a system monitor 100 according to an embodiment of the invention, a system bus 20, and one or more lithographic processing machines 10. System monitor 50 may be implemented using one or more computers, processors, and/or servers (possibly in conjunction with one or more databases), executing one or more sets of machine-executable instructions to perform a method as described herein. System 50 may also include other devices coupled to bus 20, such as a control system to control equipment 10 (e.g. via commands transmitted over bus 20) to manufacture processed wafers according to a recipe (and according to information outputted by monitor 100) and/or a bus controller to control communications over bus 20.

System bus 20 may include a standard communication bus such as a Common Object Request Broker Architecture (CORBA) bus, which carries messages packaged as CORBA objects; a Distributed Common Object Module (DCOM) bus; or one or more other standard or proprietary busses. It may be desirable for messages to be transmitted over bus 20 according to a common standard, such as the Semiconductor Equipment Communication Standard (SECS). Messages transmitted over bus 20 by equipment 10 may include alarm messages, event messages, parameter updates, triggers, etc. Depending on the particular input/output requirements of the various elements of system 50, the system may also include one or more interfaces for translating messages or objects from one form into another (e.g. DCOM to CORBA).

One approach to determining the time per state of equipment 10 would be for system monitor 50 to execute software (e.g. one or more sets of machine-executable instructions) specifically written to do so. That is, system monitor 50 would be configured to monitor which state the equipment is in and for how long. Monitor 50 would store the information and, when requested, create a report to be read online or send related data to a host (e.g. another computer, or a human operator) for offline analysis.

However, this approach may present a problem in case the model changes, or in case more details per state are requested. Such a change might be made in order to optimize throughput of the equipment, but could also be done to determine why the equipment was, for example, such in a standby state for such a long time. It is also possible that users of the equipment would want to determine the RAM of the equipment using non-ARAMS state models. To be able to handle such requests, the software would have to be changed, which could be very expensive and time consuming.

In the art, whenever SEMI standards change, or new standards are created, or a user wants to have its own view on the equipment, it has been necessary to change the equipment's software in order to build in all of the triggers and state models that may be needed. The resulting updates may be relatively time-consuming and costly, and compliance with SEMI standards may have a considerable time to market. Building customer-specific views may be too expensive and/or too slow, and when creating a new equipment generation, re-use of software may not be possible.

One embodiment of the invention provides a mechanism that uses existing, native (sub-)system state models and events, which are needed to control the equipment. These native models are tapped to create multiple views (i.e. one view state models per view) to explore the equipment's performance or to show required external behavior. Views can be added, deleted and changed without affecting the existing software in the equipment. This can happen while the equipment is performing its intended function (i.e. runtime). It is also possible to build a view on views (multi-level). For example, a state model engine according to an embodiment may also be configured to handle multiple ‘views’ in parallel and also to handle ‘views’ that were built on other ‘views’ (multilevel views, or stacked views).

A state model engine according to one embodiment is configured to determine RAM data dynamically. One such engine (which may be part of system monitor 50) functions similarly to a typical state model engine, except that its implementation does not include the state model. In other words, this engine contains the functionality to perform the associated tasks, but does not itself include a model defining which tasks to perform.

Such an engine may be implemented to execute algorithms that evaluate whether state changes occur in defined state models, based on transition events published by other state models.

Such mechanism may be designed based on the assumption that the data required to determine for the equipment state is available, but scattered through different software subsystems within the equipment. The behavior of these subsystems can be described by state models. All subsystems must publish the current state and a transition event whenever a state transition occurs. The mechanism listens to all these transition data and feeds these into a master (“equipment”) state model, that is compliant to the SEMI E58 standard. In order for the mechanism to perform the assigned task, it may be desirable for the mechanism to be able to determine if and what transitions in subsystem state models result in state transitions in the equipment state model.

A state model includes a set of triggers, e.g. of the form

<trigger>=<current state><event><condition><next state><action>.

A trigger defines when the occurrence of an event will cause a state transition: when the event occurs, the current state matches and possible conditions are met, the event will cause the trigger to execute a transition to the next state and the actions to be executed. Actions include the raising of the event signaling that a transition from a current state to the next state has occurred.

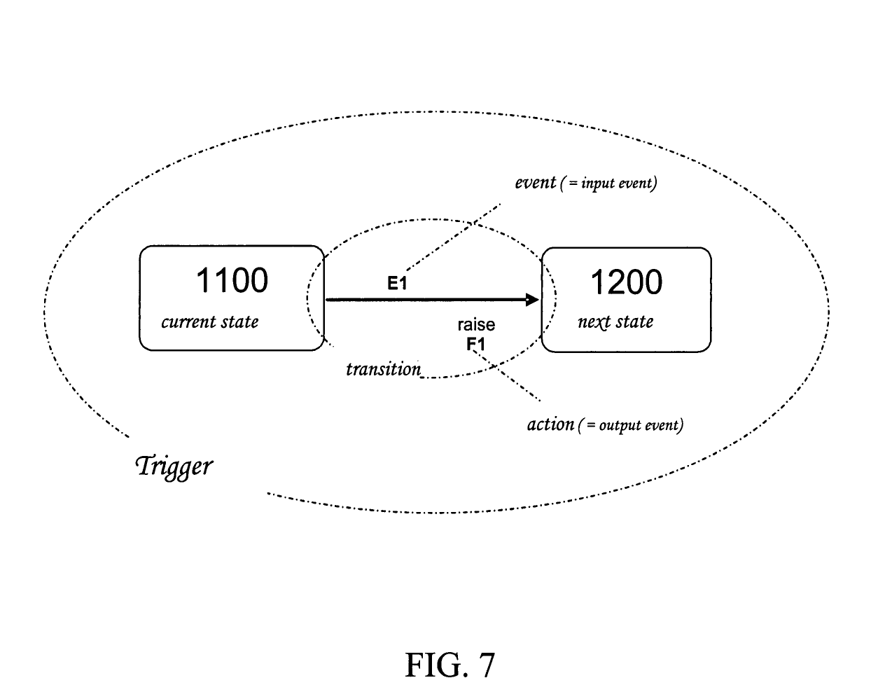

FIG. 7 shows a diagram of a state transition. In this example, event E1 occurs (an input event) and the current state of the model is 1100. Satisfaction of these two trigger requirements leads to a transition of the model to the next state 1200 and also results in action F1 (an output event).

It may be desirable for the state model to have a default superstate, which will be the active superstate after creation of the model. A default superstate is a state that becomes active when the model is first activated and no entry triggers exist. Superstates may have a history, which records the last substate that was active before the equipment transitioned out of the superstate. For transitions in which the <next state> is defined as a superstate, the history may be used to define the corresponding substate. History states are always substates. An history state is a substate that was active within a superstate, the last time the superstate was active. In case the superstate was never active before, the default substate becomes the history state.

An entry trigger defines which state to activate, the first time the state model becomes active. Entry triggers are used when it is not known beforehand what state must become active (there is no default state because the first state depends on the history of the software component which is not known beforehand as with default states). An entry trigger specifies a transition from <unknown> to <any known state>, but only when the specified event occurs. A default state specifies a transition from <unknown> to <the default state> when the model is instantiated.

An exit trigger defines when the model should be terminated. It defines a transition from <any known state> to <unknown>.

It may be desirable for every superstate to have a default substate. A default substate is a state that becomes active when the parent superstate is activated and no specific substate was specified. Default substates may be used in the following situations:

1. When this substate is the one in the default superstate, then this will be the active substate after creation of the model.

2. For transitions to a superstate for the first time, the history substate is not known. The default substate may be used as the history substate and thus will be the active substate.

3. For transitions to a superstate, the default substate will be the active state.

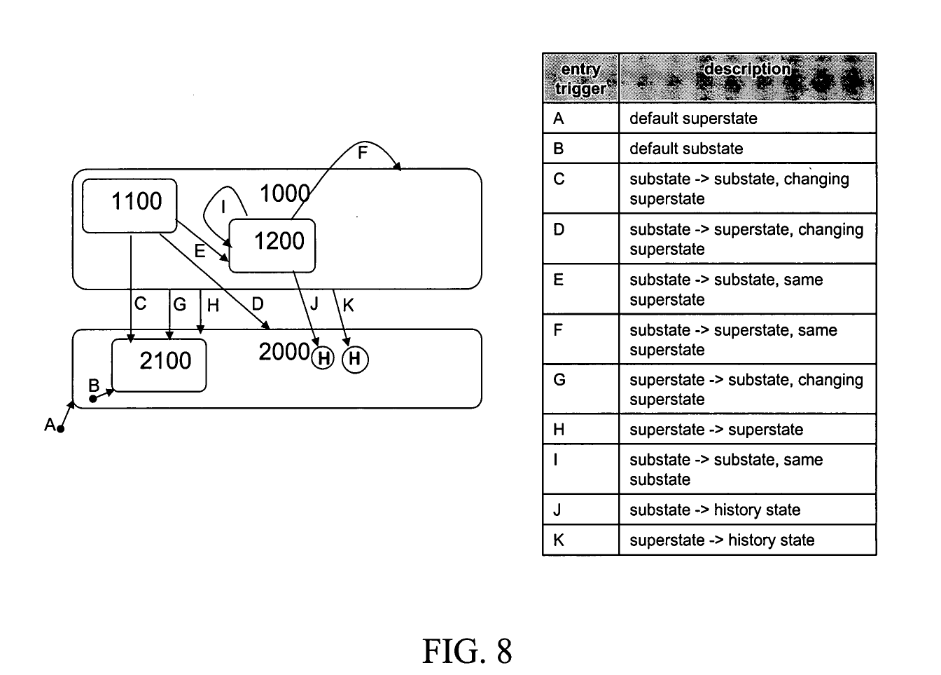

FIG. 8 shows the possible trigger types that may be defined in a state model. These triggers may indicate transitions between substates, superstates, and history states, as well as default transitions.

For some incoming events, one or more conditions must also be fulfilled to trigger a transition. A condition trigger is a trigger as defined previously specifying one or more conditions.

A Singleton State Model is a state model for which only one instance at any time will exist. A condition in a singleton state model can only reference other singleton state models. A condition in a non-singleton state model can reference any singleton state model and also any non-singleton state model if both state models belong to the same software component or hardware. MachineModel (=singleton, only one machine) can reference WaferStage (=singleton, only one waferstage). WaferModel (=non singleton, per wafer one instance) can reference MachineModel (=singleton), WaferStage (=singleton) but also WaferLocationModel (=non singleton, per wafer one instance).

A condition may be expressed with indications of one or more current states and one or more intermediate logic expressions:

<current (sub) state model x><logic><current (sub)state model y> . . .

Each state indication is TRUE when the current (sub) state of the indicated model is equal to the state defined in the condition. Evaluating the condition according to the intermediate <logic> expression(s), the outcoming condition will be TRUE or FALSE. Each <logic> expression may be a combination of, e.g., AND, OR and NOT. In this example, the <current state> of the state model is part of each <transition> of the model itself but is not part of any <condition> of the model itself.

Counters in the state model description may be expressed as:

<counter>=<event><conditions>[,<event><conditions>] . . . .

Such an expression specifies a counter with name <counter > which will be increased when either one of the given <event> occurs and the respective <conditions> are met.

The process of managing the models may be interrupted by a power-down. Therefore, it may be desirable for state and counter information to be stored in a nonvolatile location (e.g. flash RAM or other nonvolatile semiconductor memory, MRAM or other ferroelectric or magnetic-based chip memory, hard or optical disks).

Message Center: For the internal State Models (the models are not known by SH), SH acts like a message center and listens to input signals: states from internal state models (the models are not known by SH). An internal state model will publish only the lowest states to SH (i.e. no superstates).

A transition event from an internal state model may trigger a state change in a state model tracked by system monitor 50. Transition events or any occurrence of an event can cause a counter to increment.

System monitor 50 may perform state accumulation and event counting according to the Equipment State Model (ESM). Other models with counters and accumulators (e.g. user-specific models) can be run simultaneously.

Counters and accumulators that may be implemented include state history, state accumulators, and counters. A state history is an overview of the transitions that have occurred in the past. For each transition, the source and target states, the transition, and a timestamp are stored.

A state accumulator records the time that the state was in the current state. For states that have substates, the accumulator may be implemented to have a value equal to the sum of the accumulators of its direct substates. This rule may be applied recursively. When the downtime state is a superstate, then it may be desirable to accumulate the downtime to the default substate.

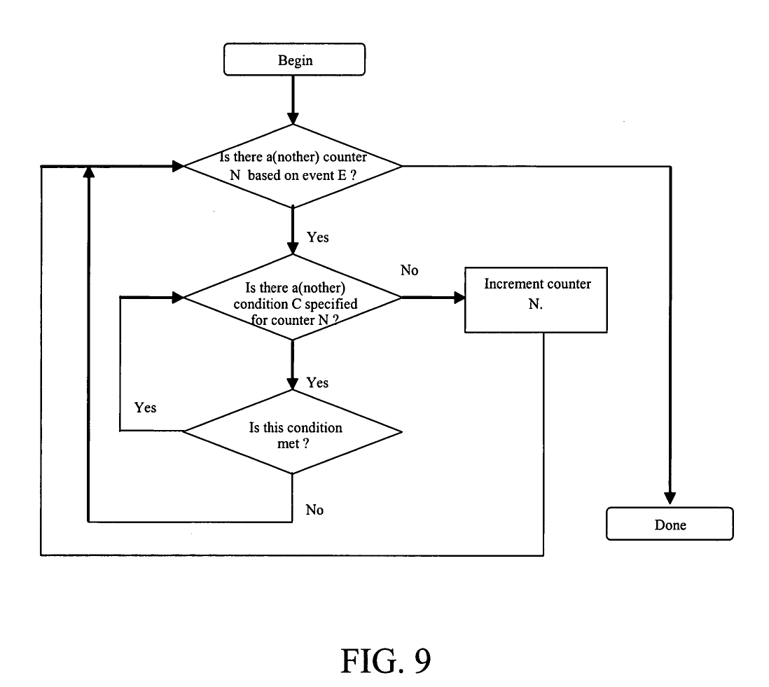

A counter counts the numbers of occurrences of transitions of specific interest. It may be desirable for a counter to have an unique name within a state model. Static verification on this syntax may be done when the counters are defined. FIG. 9 shows a flowchart of a counter event.

Lifetime counters (e.g. counters that track occurrences over the lifetime of a machine) and state accumulators may be period-independent, and may be implemented to continuously keep on counting. It may also be desirable for the user to be able to define and control event counters.

Embodiments of the invention include software to process state models, including algorithms which evaluate whether state changes occur in defined state models based on transition events published by other state models. A state model definition is provided for each state model that the software must evaluate. Such a state model definition should contain at least a set of states and a set of rules that define when a transition between these states occurs.

To have the engine determine RAM time according to a specific state model (also known as ‘view’), it may be desirable for a definition of that state model to first be written down in a file. For example, such a definition may be recorded using a human-readable, script-like, language. Such a state model definition file may then be downloaded to the equipment where it will be read by the engine. The engine may use output (e.g. events and states) from other software parts to determine RAM data according to the read definition. The resulting data may be made available on the equipment and on the host.

The rules may be configured in human-readable definition files. This gives the possibility to quickly create different views on the equipment, e.g. the mechanism is able to execute rules in a form such as “Given the current equipment state Se and an event E from a subsystem state model M and the set of current states of all subsystem state models Sm[n], transition T in the equipment state model will occur to the new state Se,” or “When an event E from a native (sub-)system state model M under the condition of current multiple (sub-)system state model status Sm[n] is received, trigger a transition T in the view state model, provided the view model is in state Sv[x].” Users may configure their own equipment state model, tuned to their specific needs. The rules may also be user-configurable, which allows the creation of customer views (by the customer) next to the views that are interesting to the equipment vendor. For ease of use, script and/or graphical editors may be provided for this flexible modeling. In one implementation, the mechanism allows at least 25 state models to be run in parallel, so different views do not exclude each other.

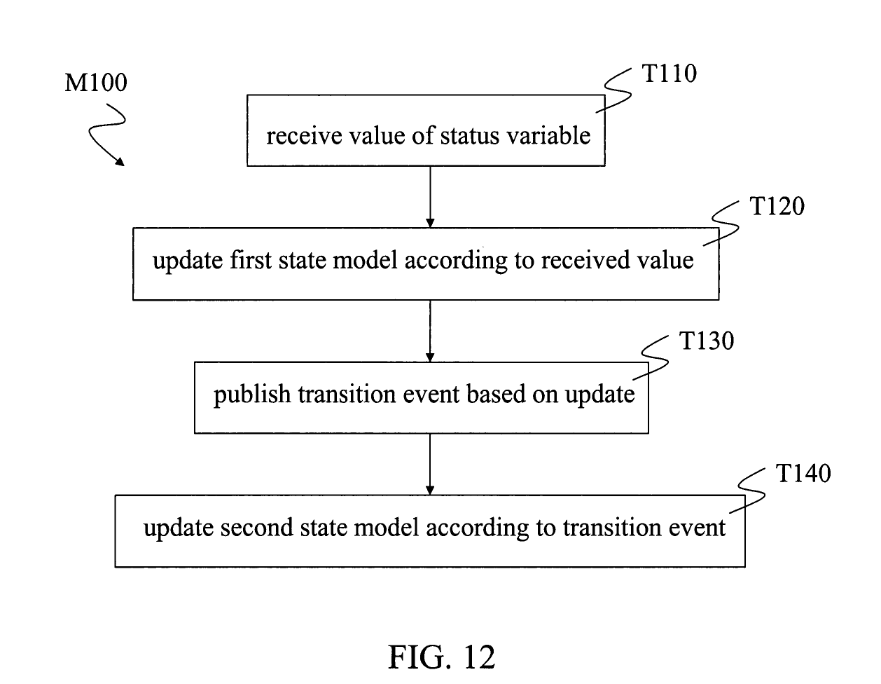

FIG. 12 shows a flowchart for a method M100 according to an embodiment of the invention. Task Ti 10 receives a value of a status variable (e.g. over bus 20). Task T120 updates a first state model according to the received value. Task T130 publishes a transition event based on the update. Task T140 updates a second state model according to the transition event.

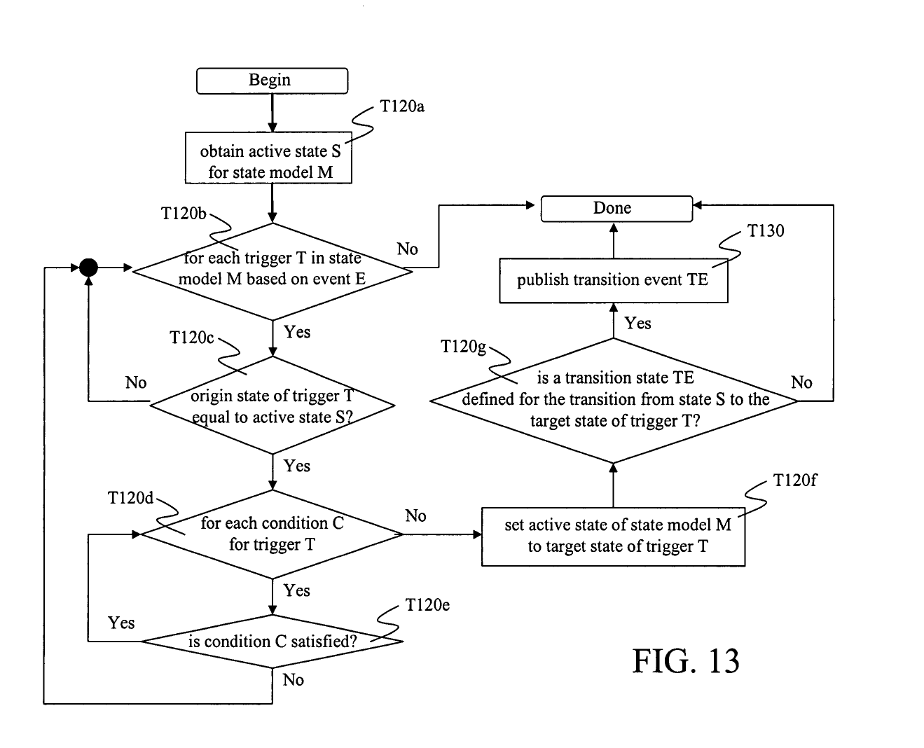

FIG. 13 shows a flowchart of one implementation of task T120 with task T130.

A mechanism according to an embodiment of the invention may be used to relieve the necessity of building hard-coded views for performance analysis, and for obtaining externally requested behavior. This may result in considerably lower software development and maintenance costs. The mechanism may be used for such standards-related tasks as obtaining SEMI compliance on standards E30, E40 (to show externally requested behavior to the host, which is used by the host to control the equipment); getting an implementation of SEMI E58 to measure the equipment's performance; and realizing SEMI E116 performance measurement requirements, which explicitly requires the use of view on views (system level view is created based on the module level views). The mechanism may also be used to follow updates on these standards, which regularly take place (reduce time to market), to implement other (future) view requirements, and/or to create views on new equipment generations (re-use). Further, the mechanism may be used during module- or system alpha- and beta-testing for (sub-)system state model verification, which may increase the system's quality.

The mechanism improves modularity and testability of the subsystems, which may reduce development and maintenance costs and time to market.

On a global level, the main software functions include counting, accumulating, and reporting. Tracking of the ARAMS state model may include the following operations: accumulating the times spent in the (sub)states of the ARAMS state model, counting the occurrences of specific events in the ARAMS state model (lifetime counters), reporting accumulated times and counters from the ARAMS state model to the host and the user interface, and/or reporting reliability reports to the ADC tool for use in Insight. Tracking custom state models may include operations such as: accumulating the times spent in the (sub)states of the custom state models, counting the occurrences of events specified by the end-user, and/or reporting accumulated times from custom state models and user-specified counters to the host and the user interface.

It may be desirable to provide (sub-)state period counters for Status Variable reporting (e.g. to the system monitor) with a resolution of 1 minute.

For each user-defined model, it may be desirable for the current state and substate to be available to the system monitor as a status variable.

It may be desirable for the system to be able to run at least twenty-five independent models, and at least four hundred counters, all at once.

It may be desirable for the software to check that each custom state model has at least one state, and/or that all entities (states, substates, transition events) within a custom state model have unique names.

It may be desirable for the software to check that each state in a custom state model has at least one defined entry and one defined exit, at least one substate, exactly one default substate, and exactly one defined downtime state or substate.

It may also be desirable for the software to check that each trigger in a custom state model is based on valid events, states, and substates from internal state models, and that each such trigger defines a transition between defined states or substates in the custom state model.

It may be desirable for the software to check that transitions in a custom state model are unambiguous, i.e. that all transitions from a (sub)state are based on different events or have mutually exclusive conditions imposed upon them.

This algorithm is used to track the ARAMS state model and custom state models. However, the algorithm can be reused for some other tasks. Two such opportunities are described below.

In a further embodiment of the invention, system monitor 50 may be used to create and/or track derived state models. A derived state model is a state model that is derived from an internal state model. It can contain a subset of the states of the model it is derived from and thus be used to filter out only the states and transitions that a client may be interested in.

It may be desirable for transition events and states from derived state models to be processed in the same manner as those from internal state models. For example, it may be desirable for such events and states to trigger state changes in the ARAMS model.

The generic algorithm can be reused by other components to compute the state of state models that are derived from internal state models. Reusing the algorithm simplifies management of all internal state models, which are related to Lot Production [ref. 1.4]. These are the Process, Lot, Operation and System state models.

Rationale: the lot production state models consist of a deeply nested structure of states. The software that implements the models operates at the lowest level (states that don't have any substates). The state model must report only transitions between “gray” states (states colored gray in the figure in [ref. 1.4]) to the host. The result is that the software needs to make a mapping between the white and the gray states and the transitions between these.

This mapping could be made by SH, by splitting each state model into two models: one that only contains the states at the lowest level and one that contains the gray states. The second model is then only dependent on the first: on some transitions in the “white” model, transitions in the “gray” model will be triggered and on others not.

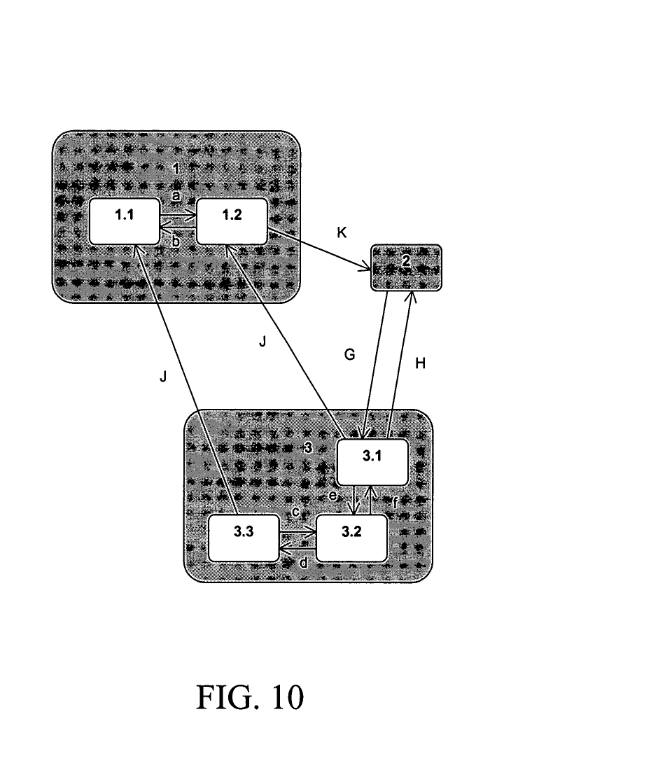

In the (fictional) state model in FIG. 10 both gray and white states are drawn. Transitions can occur between all states that are connected by an arrow and only in the direction of the arrow. The host is only interested in the transitions between the gray states. These are the arrows labeled in upper case. Note that the label ‘J’ appears twice, as from the perspective of the host, this is the same transition.

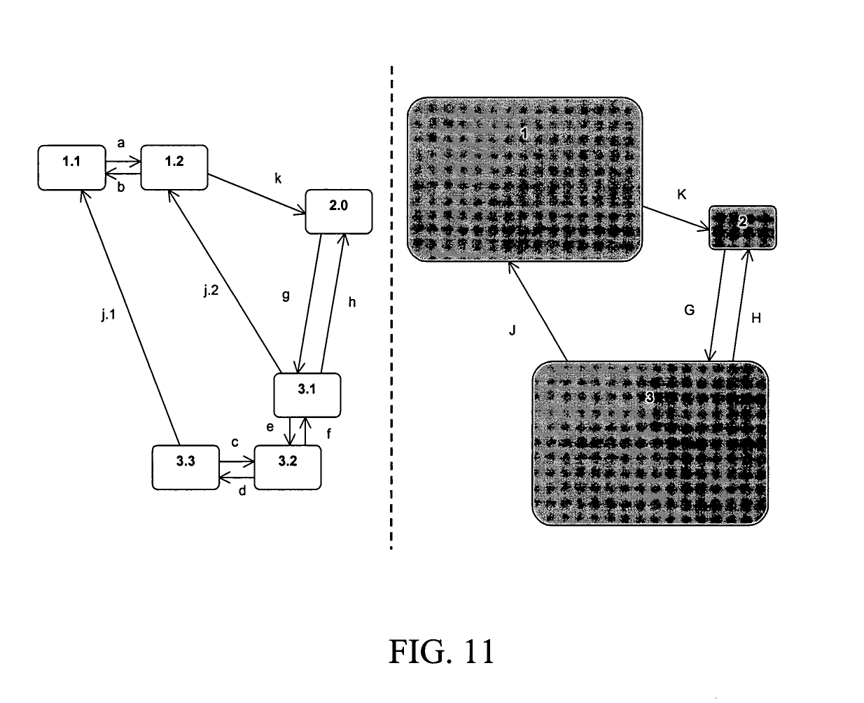

This state model could be split up into two state models as in FIG. 11. The left-hand side state model can now be implemented by the owning component. The right-hand side state model could be derived using the algorithm implemented in SH. All that is needed is a state model definition for the right-hand side model. This definition must include rules such as “if the model is in state ‘1’ and transition event ‘k’ is published by state model ‘white’ then change to state ‘2’ and publish transition event ‘K’”. Such a set of rules is exactly how state models are defined in SH, so the gray model could be perceived as just another derived state model that is tracked alongside the ARAMS state model.

In order to allow such reuse of the state model evaluation algorithm, it may be desirable to impose some additional requirements: that the system is able to track derived state models; that the derived state models cannot be edited by the user; and that transition events and states from derived state models are processed in the same manner as those from internal state models (i.e. they can trigger state changes in the ARAMS model, the custom models or other derived models).

Derived state models must not depend on states or transitions from the ARAMS state model and custom state models. This must be checked before instantiation of a derived state model.

It must be possible to have discernable derived state model instances for non-singleton type state models.

It may be desirable to forbid cyclic relations in derived state models. By definition, cyclic relations in state models exist if one or more triggers in a state model depend on a state and/or event from another state model in which one or more triggers depend on a state and/or event of the first state model. A cyclic relation exists even if the dependency is indirect (i.e. through a third state model). One potential problem with cyclic dependencies is that they can create situations where the effect of an event on state models depends on the order of processing. Therefore, it may be desirable to check dynamic relations before instantiation on the state model level. Apart from a restriction on cyclic relations, it may be allowed for derived state models to depend on other derived state models.

The SECS host must be notified of specific subsystem state transitions in the form of so-called Collection Events. A derived state model is a state model that only contains the transitions that must be reported. Using the mechanism, it uses the subsystem state transitions to determine when a Collection Event related transition occurs.

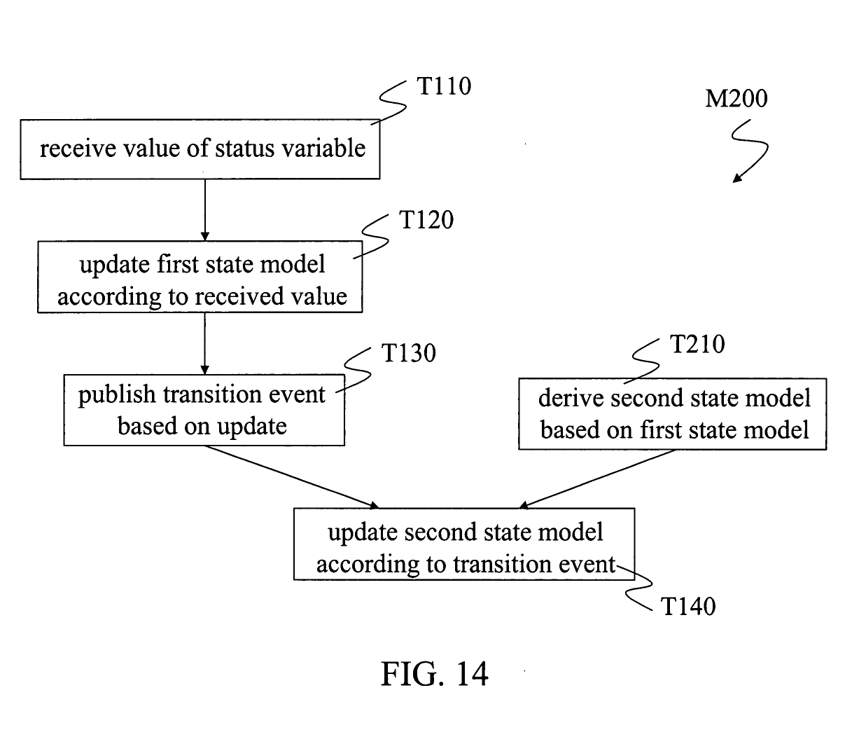

FIG. 14 shows a flowchart for a method M200 according to an embodiment of the invention. In this method, task T210 derives the second state model based on the first state model.

In a further embodiment of the invention, system monitor 50 may be used to track verification state models. Internal state models publish their state transitions. If a state model definition for an internal state model is available, the generic algorithm could evaluate a “shadow state model” for the internal state model and check whether they remain in sync.

A state model engine according to a further embodiment is also capable of verifying the implementation (behavior) of other software parts of the equipment by using so-called Verification State Models.

The mechanism allows the creation of Verification State Models. View state models are defined identical to the expected equipment, native (sub-)system state models. These so-called Verification State Models can run in parallel with the actual, physical equipment (sub-)system state behavior. Illegal transitions (e.g. transitions not defined in the view model) can be easily traced and used to fix problems in the real implementation (e.g. to solve dead-locks).

Using state model definition files for the subsystem state models, the state transitions in these state models can be verified at run-time for correctness via verification state models. This increases testability of the reliability monitoring function.

Internal state models must publish their states, because they may be input for the ARAMS, custom or derived state models. The result is that the process that evaluates these state models, has knowledge of the path of states (and the transitions between these) that each internal state model walks through. The state model definition of internal state models is not known to this process; but if it were to know the definition, it could verify whether the path contains legal transitions (i.e. transitions that are defined in the state model definition). In order for dynamic verification of state transitions to be possible, the internal state model's definition must be made available to the state evaluating process.

Such a dynamic verification could be used during development and integration to check that an implemented state model behaves according to its specification. At customer's site, this dynamic verification is continued.

For example, consider the state model as depicted in FIG. 16. Assume that the state model initially is in state 1 and that this fact has been published. Then using the state model definition, one can tell that the only valid state change that can occur is transition ‘a’ to state ‘2’. If any other state/transition combination were to be published for this state model, it would be an error.

The behavior for dynamic state model verification would be that an error is logged whenever an internal state model performs an illegal transition. These errors must also be included into the reporting, because the reported data may be incorrect due to the detected illegal transition. Because the verification mechanism cannot tell why verification failed, it is not possible at run-time to recover from such a situation.

A verification model may be applied to track one or more of the following: illegal transitions (transition from a source to a target state between which no transition is defined), wrong transitions (the published transition is not defined in the state model or is not a transition between source and target state), and illegal states (transition to a target state, where the target state is not defined in the state model definition, or the target state is not known).

Each internal state model should supply a state model definition file for dynamic verification. The component that owns the internal state model must supply a state model definition for the purpose of dynamic verification. Dynamic verification is performed when and only when a state model definition is supplied.

Verification is started for an instance of a state model when (A) the state model instance is created and (B) a verification state model definition file is available for the state model class. Verification is stopped for an instance of a state model when the instance is destroyed.

The software will log a warning for all detected illegal transitions, all detected wrong transitions, and all detected illegal states. All logged verification errors are included in the Equipment State History report. Published warnings in the error log must contain information of the model and transition, thus <model><current state><transition><next state>. To prevent logging pollution, a maximum of 20 warnings per instance are allowed to be logged. When more warnings occur, than dynamic verification of that instance must be disabled, and one more warning must be logged that the dynamic verification is disabled.

It may be desirable for the verification state model to be forced to follow its source. When the incoming transition has errors, for example, it may be desirable for the verification state model still to jump to the next state as defined in the transition. Forcing such action avoids a condition in which the verification state model becomes out-of-sync after a wrong transition of its “master” (e.g. prevents a continuous loop of publishing warnings).

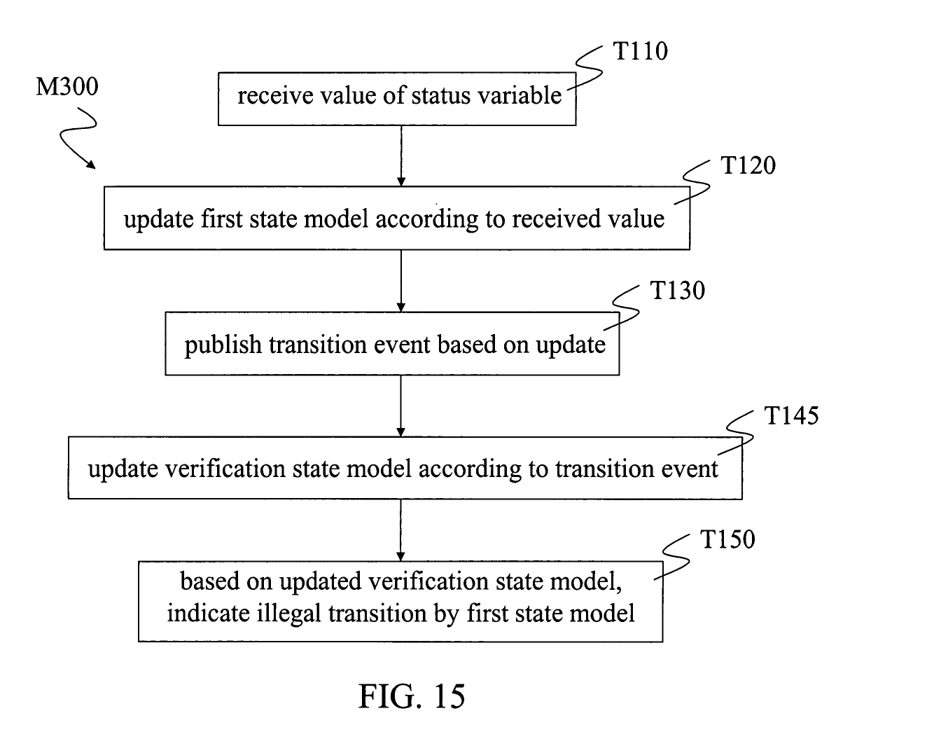

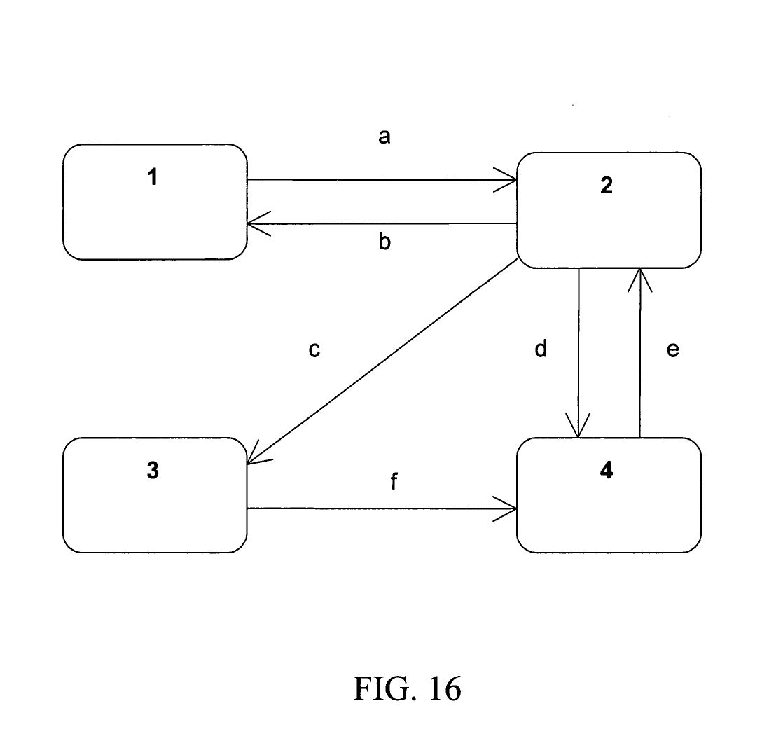

FIG. 15 shows a flowchart for a method M300 according to an embodiment of the invention. In this method, task T145 updates a verification state model according to the transition event published by task T130. Task T150 indicates an illegal transaction by the first state model, based on the updated verification state model.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

The foregoing presentation of the described embodiments is provided to enable any person skilled in the art to make or use the present invention. Various modifications to these embodiments are possible, and the generic principles presented herein may be applied to other embodiments as well. For example, the invention may be implemented in part or in whole as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a microprocessor or other digital signal processing unit.

Embodiments of the invention include a computer program containing one or more sequences of machine-readable instructions describing a method as disclosed above, or a data storage medium (e.g. semiconductor memory, magnetic or optical disk) having such a computer program stored therein. Thus, the present invention is not intended to be limited to the embodiments shown above but rather is to be accorded the widest scope consistent with the principles and novel features disclosed in any fashion herein.

What is claimed is:

1. A method of controlling a lithographic processing machine, said method comprising:
based on occurrence of a trigger event, recording a transition of a first state model of the machine;
based on a transition event corresponding to the transition, updating a second state model of the machine.

2. The method of controlling a lithographic processing machine according to claim 1, wherein the first state model is specified by a standard.

3. The method of controlling a lithographic processing machine according to claim 2, wherein said standard includes a SEMI standard.

4. The method of controlling a lithographic processing machine according to claim 3, wherein said SEMI standard includes SEMI E10, E30, E40, or SEMI E58.

5. The method of controlling a lithographic processing machine according to claim 1, wherein the trigger event is based on a change of a status variable.

6. The method of controlling a lithographic processing machine according to claim 1, said method comprising deriving the second state model from the first state model.

7. The method of controlling a lithographic processing machine according to claim 1, wherein said first state model and said second state model include a substate, a superstate and an history state.

8. A computer product having machine executable instructions, said instruction executable by a machine to perform a method of controlling a lithographic processing machine, the method comprising:
based on occurrence of a trigger event, recording a transition of a first state model of the machine;
based on a transition event corresponding to the transition, updating a second state model of the machine.

9. The computer product according to claim 8, wherein the first state model is specified by a standard.

10. The computer product according to claim 9, wherein said standard includes a SEMI standard.

11. The computer product according to claim 10, wherein said SEMI standard includes SEMI E10, E30, E40, or SEMI E58.

12. The computer product according to claim 8, wherein the trigger event is based on a change of a status variable.

13. The computer product according to claim 9, said method comprising deriving the second state model from the first state model.

14. The computer product according to claim 9, wherein said first state model and said second state model include a substate, a superstate and an history state.

15. A system monitor configured to control a lithographic processing machine, the system monitor comprising:
a processor configured to record a transition of a first state of the machine based on occurrence of a trigger event, and to update a second state model of the machine based on a transition event corresponding to the transition.

16. The system monitor according to claim 15, wherein said system monitor is configured to dynamically determine data related to reliability, availability and maintainability of the processing machine.

17. The system monitor according to claim 15, wherein said processor is configured to record and read a state model defined in human readable language.

18. The system monitor according to claim 15, further comprising an accumulator configured to record time that has elapsed in said first state model.

19. The system monitor according to claim 15, further comprising a counter configured to count said occurrence.
